(19) United States
(12) Patent Application Publication
(10) Pub. No.: US 2003/0233329 A1
(43) Pub. Date: Dec. 18, 2003

(54) System and method for providing subscription content services to mobile devices

(75) Inventors: Othman Laraki, Cambridge, MA (US); Chung Huan Liu, Los Gatos, CA (US); Sergei Krupenin, Oakland, CA (US); Mingzhe Zhu, San Jose, CA (US); Daniel F. Zucker, Palo Alto, CA (US)

Correspondence Address: O'MELVENY & MYERS LLP, 400 So. Hope Street, Los Angeles, CA, 90071-2899, US

(73) Assignee: ACCESS SYSTEMS AMERICA, INC.

(21) Appl. No.: 10/313,796

(22) Filed: Dec. 6, 2002

Related U.S. Application Data
(60) Provisional application No. 60/338,323, filed on Dec. 6, 2001.

(51) Int. Cl. G06F 17/60

(52) U.S. Cl. 705/52

(57) ABSTRACT

The present invention relates to a method and system for providing content services to mobile devices. The method and system should provide these content services to the mobile devices while ensuring user privacy. The method and system should also allow one or more content providers that provide the content services to collect payment for the use of the content services. In one embodiment, a user makes a request for content from an affiliated content provider (Affiliated Content Provider A). This request travels from the wireless device (where it is a request over a radio frequency) thru one or more wireless infrastructure devices until it arrives as a Hypertext Transfer Protocol (HTTP) request over an Ethernet to a proxy server. The proxy server then requests the source Internet Protocol (IP) address of the wireless device that sent the request. The proxy server then sends the IP address to an identity agent having a very reliable database and is given a user identifier (or UID) to that IP address from the identity agent in return. The proxy server then looks at the HTTP request to determine IP address (or service ID) for the content provider. Using an algorithm, a unique content provider-specific identifier (or subnym) is calculated as the UID and the service ID (or, if it was already calculated, it can be looked up in a table where the previous calculation was recorded). The subnym is attached to the HTTP request by means of inserting an additional header (x-access-subnym) to the request. The HTTP request is forwarded to the affiliated content provider with the appended subnym. The affiliated content provider uses the subnym to determine the identity of the user.

### RELATED APPLICATION DATA

This application claims priority pursuant to 35 U.S.C. §119(e) to U.S. Provisional Application No. 60/338,323, filed Dec. 6, 2001, for SYSTEM AND METHOD FOR PROVIDING SUBSCRIPTION CONTENT SERVICES TO MOBILE DEVICES.

### BACKGROUND OF THE INVENTION

1. Field of the Invention

The present invention relates generally to wireless communications systems and, in particular, to a system and method for providing subscription content services to mobile devices.

2. Description of the Related Art

With the convergence of the Internet and wireless communications systems, individuals have the ability to access a wide variety of stored content on their mobile devices. In a common approach, a mobile device is adapted to establish a data communications link with a mobile network that is connected to the Internet. The mobile device typically includes a web browser interface that allows its user to request content from web servers connected to the Internet. Due to the constraints of mobile devices, content providers often serve different content to mobile devices than is served to other network devices such as personal computers. For example, a personal computer will typically have a larger display and greater memory and processing capabilities than a mobile device, and may be connected to the Internet at higher access speeds. As a result, many content providers serve large graphics and multimedia files to personal computer users, and predominately text-based content to mobile devices.

Many content providers obtain revenue through advertisements served to end-users along with the requested content. Such advertisements may include banner advertisements and other advertisements that are embedded within the served content, and pop-up windows that display advertisements in a separate browser. These advertising techniques are not desirable, however, for use with most mobile devices where the small screens and limited interfaces leave little room for banner advertisements and pop-up windows. Many mobile users have chosen instead to pay for access to content that is specially formatted for mobile devices and is delivered without unwanted advertisements.

A standard subscription service requires the mobile user to sign up for a subscription in order to retrieve premium content from the content provider. A subscription process typically requires the mobile user to set up an account with the content provider, which may include selecting a username and password, and submitting credit card information for billing a periodic fee. Each time the mobile user wishes to retrieve premium content, the mobile user must log into the content provider's web site and enter the username and password.

There are many drawbacks to subscribing to premium content in the manner described above. For example, there are numerous content providers that offer content to users of mobile devices, requiring the user to subscribe separately to the services offered from each content provider. Because usernames may be rejected by a content provider, the mobile user may have to remember different username and password combinations, and to which subscription services the log-in information corresponds. In addition, the mobile user will be billed separately for each subscription and must separately cancel each subscription when content is no longer desired.

In view of the above, there is a need in the art for a subscription content service that is efficient for both the user and the subscription carrier.

### SUMMARY OF THE INVENTION

The present invention relates to a method and system for providing content services to mobile devices. The method and system should provide these content services to the mobile devices while ensuring user privacy. The method and system should also allow one or more content providers that provide the content services to collect payment for the use of the content services.

In an embodiment of the present invention, a wireless communications system includes a content provider, a first network, a proxy server coupled with the content provider via the first network, a second network, and a wireless device server coupled with the proxy server via the second network. The wireless device is associated with a first wireless device identifier and a second wireless device identifier. The content provider is associated with a first content provider-specific identifier and a second content provider-specific identifier. The proxy server is implemented using a table. The table includes the first content provider-specific identifier. The wireless device provides the second content provider-specific identifier to the proxy server. The proxy server uses the first wireless device identifier to identify the second wireless device identifier. The proxy server uses the second wireless device identifier and the second content provider-specific identifier to identify the first content provider-specific identifier on the table. The proxy server adds the first content provider-specific identifier to a header. The proxy server forwards the modified first content provider-specific identifier to the content provider. Lastly, the content provider uses the modified first content provider-specific identifier to determine an identity of the wireless device. The first wireless device identifier may be an internet protocol (IP) address assigned to the wireless device. The second wireless device identifier may be an International Mobile Subscriber Identifier. The first content provider-specific identifier may be a unique alias sharable with the content provider or a subnym. The second content provider-specific identifier may be a Uniform Resource Locator (URL) assigned to the content provider.

In yet another embodiment of the invention, a user of a wireless device makes a request on the wireless device for content from an affiliated content provider. This request travels from the wireless device (where it is a request over a radio frequency) thru one or more infrastructure devices until it arrives as a Hypertext Transfer Protocol (HTTP) request to a proxy server. Using standard socket Application Program Interfaces, the proxy server requests the source IP address for wireless device making the request. The proxy server then sends the IP address to an identity agent and is given a subscriber identifier corresponding to the IP address. The proxy server then looks at the HTTP request to determine which server's data is being requested. This server is determined to be associated with the affiliated content provider. The proxy server then uses an algorithm to calculate a unique provider-specific identifier or subnym from the subscriber identifier and an identifier associated with the content provider. The unique provider-specific identifier is attached to the HTTP request by means of inserting an additional header to the request. The HTTP request is forwarded to the affiliated content provider with the appended subnym. The affiliated content provider then uses the appended subnym to determine the identity of the user.

A more complete understanding of the present invention will be afforded to those skilled in the art, as well as a realization of additional advantages and objects thereof, by a consideration of the following detailed description of the embodiment. Reference will be made to the appended sheets of drawings, which will first be described briefly.

### BRIEF DESCRIPTION OF THE DRAWINGS

The drawings illustrate the design and utility of preferred embodiments of the invention. The components in the drawings are not necessarily to scale, emphasis instead being placed upon illustrating the principles underlying the embodiment. Moreover, in the drawings, like reference numerals designate corresponding parts throughout the different views.

FIG. 1 illustrates a preferred embodiment for facilitating communication between wireless devices and content providers according to the invention;

FIGS. 2a and 2b illustrate a preferred operation of a server system according to an embodiment of the invention;

FIG. 3 illustrates a preferred subscription process according to an embodiment of the invention;

FIG. 4 illustrates a first alternate embodiment for facilitating communication between wireless devices and content providers according to the invention;

FIG. 5 illustrates a second alternate embodiment for facilitating communication between wireless devices and content providers according to the invention;

FIG. 6 illustrates a third alternate embodiment for facilitating communication between wireless devices and content providers according to the invention;

FIG. 7 illustrates a fourth alternate embodiment for facilitating communication between wireless devices and content providers according to the invention;

FIG. 8 illustrates a fifth alternate embodiment for facilitating communication between wireless devices and content providers according to the invention;

FIG. 9 illustrates a sixth alternate embodiment for facilitating communication between wireless devices and content providers according to the invention;

FIG. 10 illustrates a seventh alternate embodiment for facilitating communication between wireless devices and content providers according to the invention;

FIG. 11 illustrates an eighth alternate embodiment for facilitating communication between wireless devices and content providers according to the invention;

FIG. 12 illustrates a network layout according to an embodiment of the invention;

FIG. 13 illustrates an interface usage map according to an embodiment of the invention; and

FIG. 14 illustrates a carrier infrastructure integration according to an embodiment of the invention.

### DETAILED DESCRIPTION OF THE PREFERRED EMBODIMENTS

In the detailed description that follows, like element numerals are used to describe like elements illustrated in one or more of the aforementioned figures.

A preferred embodiment of the present invention is illustrated in FIG. 1. A mobile network 10 facilitates communications between a plurality of wireless devices, such as wireless device 12, and a plurality of content providers, such as affiliated content provider 14 and non-affiliated content provider 16. The mobile network 10 may be any wireless communications system that supports at least one multiple-access wireless communications protocol such as General Packet Radio Services (GPRS), High Data Rate (HDR), Wideband Code Division Multiple Access (WCDMA) or Enhanced Data Rates for GSM Evolution (EDGE). The wireless device 12 may be any device, whether stationary or mobile, that is adapted for wireless communications with the mobile network 10, such as a cellular telephone, pager, personal digital assistant (PDA), vehicle navigation system or portable computer.

The mobile network 10 connects the wireless device 12 to the content providers 14 and 16 through a subscription system 18 and a network 20, such as the Internet. The mobile network 10 is operated by a carrier that has an established billing relationship with its mobile customers, including wireless device 12, for use of the wireless services provided through the mobile network 10. Billing information for each mobile customer is maintained by a billing system 26 that is connected to the mobile network 10 through the subscription system 18. The subscription system 18 is adapted to manage the provision of subscription services between the wireless device 12 and the affiliated content provider 14, and includes a proxy server 22 and a subscription management server (SMS) 24. It will be appreciated that the proxy server 22 and SMS 24 may be implemented on one or more physical servers.

The subscription system 18 implements a content subscription model that allows affiliated content providers 14 to exploit the billing capabilities of the carrier. In a preferred embodiment, an affiliated content provider 14 is a web site that offers subscription content to the wireless device 12 and has agreed to bill the mobile user through the billing system provided through the subscription system 18. Non-affiliated content providers 16 include internet web sites that do not use the billing services provided by the subscription system 18. The subscription system 18 interfaces with the carrier's pre-paid and post-paid billing systems and includes a revenue share system to manage revenue share agreements that may be entered between the carrier and affiliated content providers. In addition, the subscription system 18 includes registration services for subscribing the mobile user to the services offered by the affiliated content provider 14, identifies the mobile user to the affiliated content provider 14 when subscription content is requested and interfaces with the carrier's billing system.

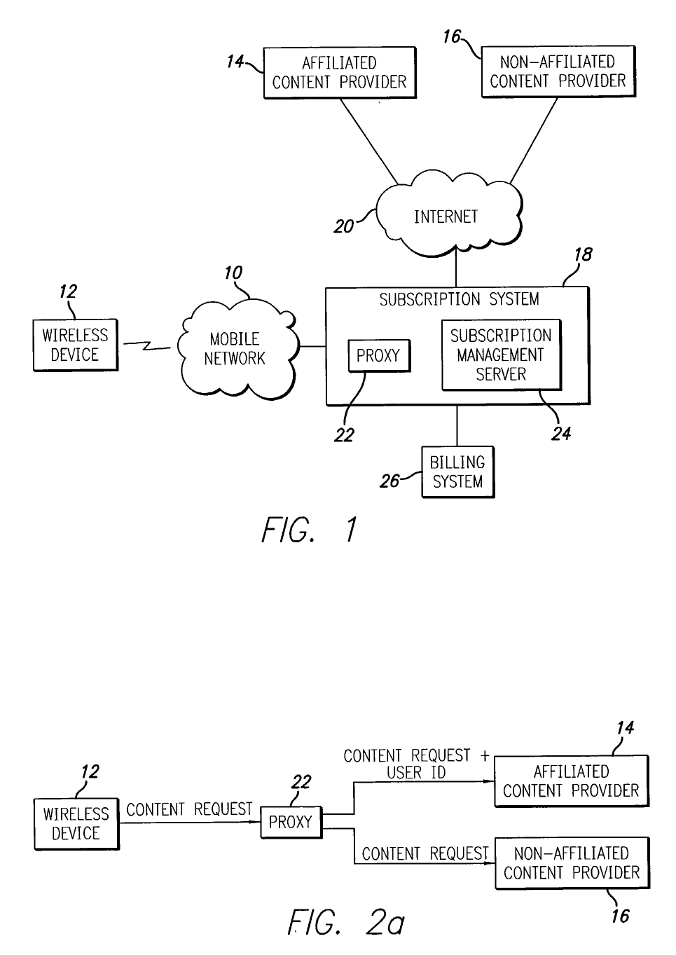

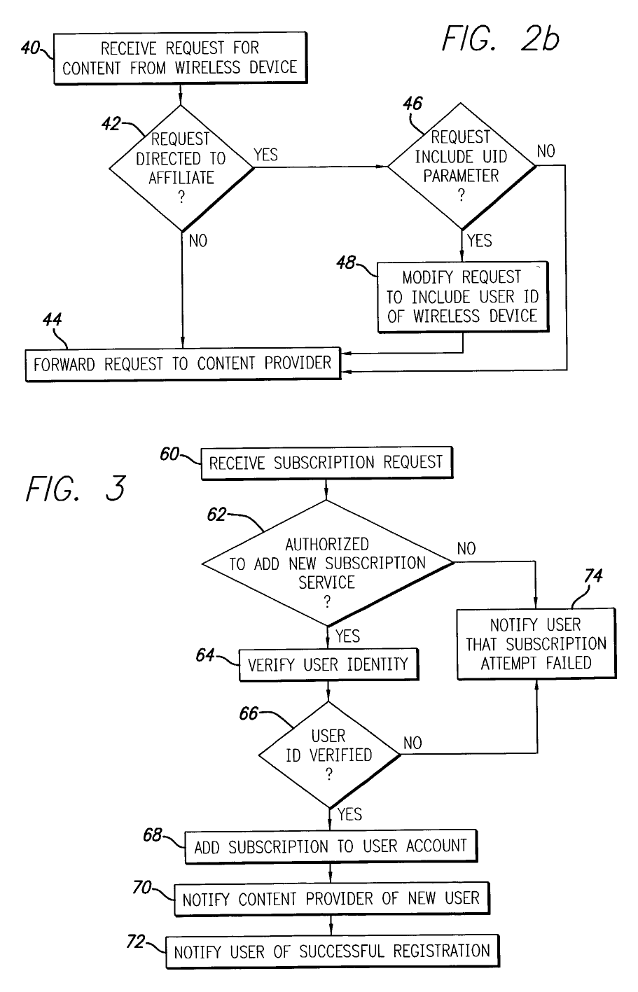

A preferred operation of the server system 18 will now be described with reference to FIGS. 2a and 2b. Each content provider 14 and 16 includes at least one server that is connected to the Internet 20 and adapted to transmit and receive Hypertext Transfer Protocol (HTTP) data. In addition, the wireless device 12 includes a communications interface, such as a web browser, through which the wireless device 12 may transmit and receive HTTP data. The mobile user may request content from one of the content providers 14 and 16 by entering the Uniform Resource Locator (URL) in the web browser or selecting a link to the requested content. It should be appreciated that in alternate embodiments, any protocol may be used between the wireless device 12 and the content providers 14 and 16, provided that the protocol allows the wireless device 12 to request and receive content from the content provider.

In this embodiment, all mobile HTTP requests are routed through the proxy server 22 and forwarded to the appropriate content provider 14 and 16 in accordance with the flow diagram of FIG. 2b. In Step 40, the proxy server 22 receives a content request transmitted from the wireless device 12, and in Step 42, the proxy server 22 determines whether the request is directed to an affiliated content provider 14 or a non-affiliated content provider 16. A request is typically in the form of a URL that identifies the content provider and the requested content. If the request is directed to a non-affiliated content provider 16, then the content request is forwarded to the non-affiliated content provider in Step 44.

If the request is directed to an affiliated content provider 14, the proxy server 22 determines whether the request includes a parameter for a user identifier (UID) in Step 46. If a UID parameter is found, the proxy server 22 determines the mobile user's unique UID and replaces the parameter with the UID in Step 48. In a preferred embodiment, the syntax of the request is the parameter and known to both the affiliated content provider 14 and the proxy 22. In an alternate embodiment, each affiliated content provider 14 may use different syntax. The modified request is then forwarded to the affiliated content provider 14 in Step 44. The affiliated content provider 14 may use the UID information from the request to automatically authenticate the identity of the mobile user before delivering subscription content. Referring back to Step 46, if the proxy server 22 is unable to locate UID parameter, then the request is forwarded to the affiliated content provider 14 without modification in Step 44.

When the mobile user requests subscription content from the content provider 14, the content provider 14 retrieves the mobile user's UID from the request and determines whether the mobile user is authorized to view the content. In a preferred embodiment, the affiliated content provider 14 includes an authorization database that stores authorized UIDs and the mobile user is authorized if the mobile user's UID is found in the authorization database. If the mobile user is a subscriber, then the affiliated content provider 14 transmits the requested content to the wireless device 12 through the proxy server 22. If the user is not authorized to view the subscription content, then the affiliated content provider 14 transmits a message to the wireless device 112 informing the mobile user that the requested content requires a subscription. In a preferred embodiment, the affiliated content provider 14 transmits a hypertext link to the wireless device 112 that, when selected by the mobile user, will initiate a subscription process.

A preferred embodiment of a mobile user subscription process will now be described with reference to the flow diagram of FIG. 3. When selected, the link generates a HTTP request that is routed to the subscription management server (SMS) 24. The HTTP request includes the information necessary for the SMS 24 to subscribe the mobile users to the requested content, including an identification of the affiliated content provider 14 and an identification of the requested content. The SMS 24 receives the subscription request in Step 60 and, in Step 62, verifies whether the mobile user is authorized to add the new subscription. In a preferred embodiment, the authorization determination is made in accordance with the mobile user's current account as maintained through the billing system 26.

If the mobile user is authorized to add the new subscription service then, in the Step 64, the SMS 24 verifies the identity of the user. In a preferred embodiment, the SMS transmits a screen requesting that the mobile user enter a secret password to verify the mobile user's identity. If the password matches a stored password, then the identity of the mobile user is verified and the SMS 24 adds the subscription to the user's account in Step 68. In Step 70, the SMS 24 transmits a message to the affiliated content provider 14 to provide notification that the new subscriber was added. In Step 72, the SMS transmits a message to the wireless device 112 to provide notification that the subscription was successful. In a preferred embodiment, the message includes a link to the subscription content that was originally requested. Referring back to Steps 62 and 66, if the mobile user is not authorized to add the new subscription service or if the identity of the user cannot be verified, a message is sent to the wireless device 12 in Step 74 to notify the mobile user that the subscription could not be added.

The mobile user may unsubscribe from a subscription service in a similar manner. The mobile user selects an unsubscription link (e.g., from a web page provided by the affiliated content provider 14 or the subscription system 18). In alternate embodiments, the unsubscription service may be initiated by the carrier or the affiliated content provider 14. For example, the carrier may unsubscribe a mobile user from an affiliated content provider 14 if the mobile user ceases to be a customer of the carrier. The unsubscription service is managed by the SMS 24 which, after receiving an unsubscription request, verifies the mobile user's identity, then deactivates (or deletes) the subscription service from the mobile user's database and sends an unsubscription message to the content provider.

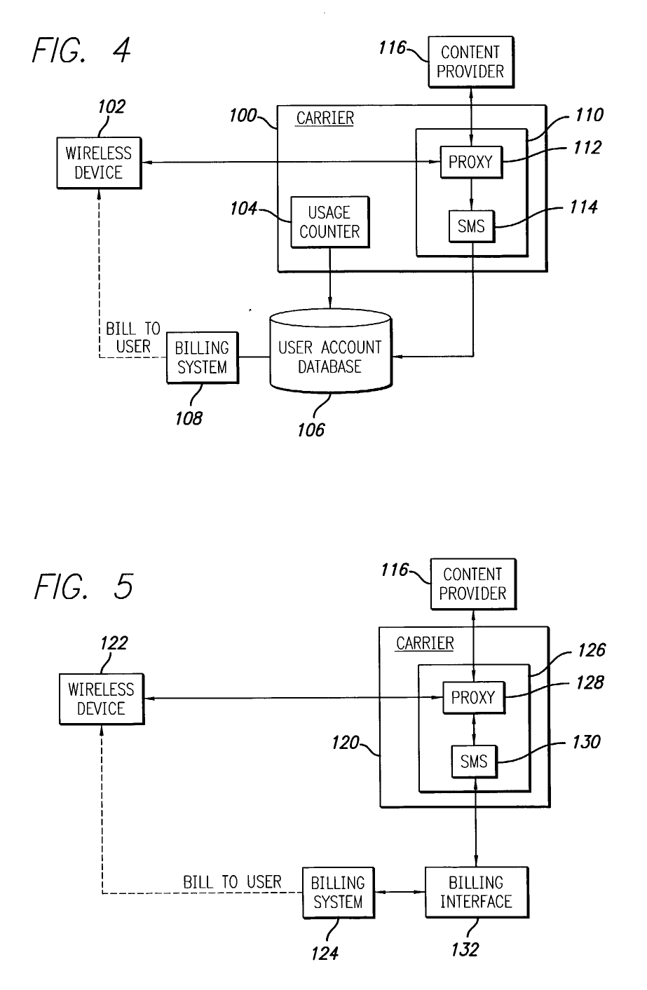

A first alternate embodiment of the present invention is illustrated in FIG. 4. A carrier 100 provides wireless services to its wireless customers, such as wireless device 102. The carrier 100 has an established billing relationship with its wireless customers based on a pay-per-use model. When the wireless device 102 accesses the wireless communications services of the carrier 100, a usage counter 104 tracks the usage and stores relevant usage data in the user database 106. In a preferred embodiment, the usage counter tracks the amount of time in minutes that the wireless device 102 accesses the wireless services. In alternate embodiments, the usage counter 104 may track the number of data packets transmitted to the wireless device 102, track the number of bytes, or count other usage criteria. The carrier 100 also includes a billing system 108 that calculates a bill for the mobile user based on the stored user data 106.

The carrier 100 also includes a subscription system 110 that is adapted to bill the wireless device 102 for access to subscription content on a pay-per-use basis. The subscription system 110 includes a proxy server 112 and an SMS 114. When the proxy server 112 receives a request from the wireless device 102 for access to a subscription service, the proxy server 112 first determines whether the requested content provider is an affiliate content provider, and if so, adds user identification information where appropriate. The proxy server 112 then forwards the host system of the requested content provider and the UID of the mobile user to the SMS 114. In a preferred embodiment, the SMS 114 requests the authorization information from the billing system 108 through a billing interface (not shown). If the mobile user is authorized to access the subscription service, then the SMS 114 determines the current value of the usage counter 104 for the mobile user and logs the counter value, the subscription service ID and the UID in the user account database 106. The content request is then forwarded from the proxy server 112 to the affiliated content provider 116. The billing system 108 is connected to the user account database 106 and, based on the stored data, periodically bills the mobile user of the wireless device 102 for usage of the carrier 100 and subscription services. It will be appreciated that the present embodiment supports numerous pay-per-use pricing models.

A second alternate embodiment will now be described with reference to FIG. 5. A carrier 120, provides wireless services to its wireless customers, such as wireless device 122. The carrier 120 has an established billing relationship with each of its wireless customers based on either a pre-paid or post-paid model. A pre-paid customer starts with a funded account balance that is decremented as the user access subscription services. A post-paid customer starts with an account balance of zero and is billed after subscription services are accessed. The carrier 100 is connected to a billing system 124 that is adapted to handle both pre-paid or post-paid customer accounts.

The carrier 120 includes a subscription system 126 that includes a proxy server 128 and a SMS 130. A billing interface 132 is adapted to receive requests for UID authorization from the SMS 130, access data from the billing system 124 to determine the associated account status, determine whether the associated user is authorized to subscribe to a new subscription service and return the authorization results to the SMS 130. It will be appreciated that the billing interface 132 may be adapted to support multiple billing models, without requiring modification of the SMS 130. The SMS 130 merely requests authorization to bill the subscription service from the billing interface 132, which makes the necessary determination in accordance with the billing method and account status of the mobile user. If the UID is authorized, then the SMS 130 adds the mobile user to the subscription service and instructs the billing interface 132 to update the mobile user's account. For example, if the mobile user is a pre-paid customer, the billing interface 132 may instruct the billing system to deduct the subscription fee from the account balance.

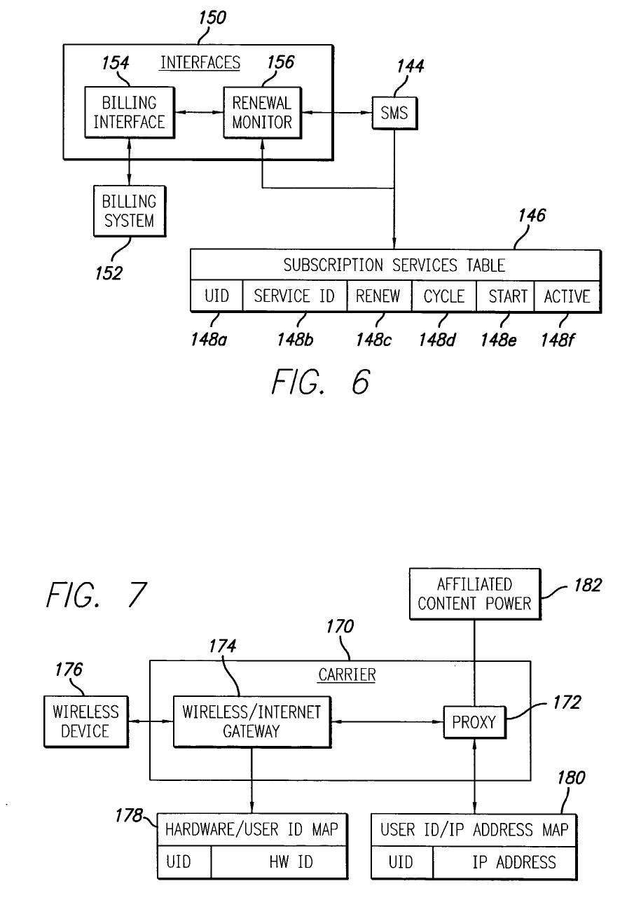

A third alternate embodiment will now be described with reference to FIG. 6. An SMS 144 manages subscription information that includes a subscription length for each subscription. The SMS 144 is further adapted to handle one-off payments by designating short subscription lengths in the subscription information. In one embodiment, the SMS 144 stores subscription information in a subscription services table 146. The subscription services table 146 preferably includes the following fields: UID 148a, service ID 148b, renew 148c, cycle 148d, start 148e and active 148f. The UID 148a and service ID 148b fields uniquely identify the subscription service. The start 148e field indicates the start date of the subscription service, the cycle 148d field indicates the cycle length for each renewal period, after which the mobile user having the UID 148a will be charged for the subscription service, and the renewal 148c field indicates whether the subscription should be renewed at the end of the current cycle. The active 148f field indicates whether the identified user is currently subscribed to the subscription system. The subscription services table 146 is populated by the SMS 144 during the subscription process. It will be appreciated that the system services table 146 is merely one contemplated embodiment for storing and maintaining subscription information.

Interfaces 150 are provided between the SMS 144 and a billing system 152. The interfaces 150 include a billing interface 152 and a renewal monitor 154. The renewal monitor 154 runs periodically and determines when to bill the mobile user for subscription services and when to deactivate expired subscription services. In a preferred embodiment, the renewal monitor 154 determines when the current cycle of a subscription service has expired and takes appropriate action. For example, if the current cycle has expired and the renewal field 148c is set to “Yes,” then the renewal monitor 154 instructs the billing interface 152 to bill the associated mobile user for another cycle of the subscription service. If the renewal field 148c is set to “No,” then the renewal monitor 154 deactivates the subscription service by setting the active field 148f to “false.” The subscription services table 146 can also be used to pay for onetime charges, such as downloading a music file. For a one-time purchase, the SMS 144 sets the renewal field 148c to “No” and sets a short cycle length in the cycle field 148d (e.g., 1 hour).

A fourth alternate embodiment will now be described with reference to FIG. 7. A carrier 170 includes a proxy server 172 and a wireless/Internet gateway 174. When a wireless device 176 connects to the carrier 170, the wireless/Internet gateway 174 receives a hardware identifier from the wireless device 176 and assigns an available IP address to the wireless device 176. The wireless/Internet gateway 174 is coupled to a lookup table 178 that stores a mapping of UIDs to hardware IDs. The wireless/Internet gateway 174 looks up the received hardware ID and transmits the corresponding UID and the assigned IP address to the proxy server 172 to notify the proxy server 172 that a new device has connected to the network. The proxy server 172 maintains a lookup table 180 that maps UIDs to assigned IP addresses and stores the received UID/IP address pair in the lookup table 180.

When the proxy 172 receives a request from the wireless device 176 for content from an affiliated content provider 182, the proxy receives the IP address assigned to the wireless device 172. The proxy 172 then looks up the received IP address in the lookup table 180 to determine the corresponding UID. The proxy 172 may then insert the UID into the request to identify the wireless device 172 to the affiliated content provider 182.

A fifth alternate embodiment will now be described with reference to FIG. 8. FIG. 8 illustrates the application of a secure SSL connection between a wireless device 190, a proxy server 192 and a content provider 194. It will be appreciated that the proxy server 192 cannot modify the request from the wireless device 190 to the content provider 194 to include the UID if an SSL connection is established between the wireless device 190 and the content provider 194. Consequently, where SSL encryption is desirable for use by a content provider, the process illustrated in FIG. 8 may be used. First, in Step 200, the request is sent in the clear from the wireless device 190 to the proxy 192. The proxy 192 adds the UID to the request in Step 202 and, in Step 204, the proxy server initiates an SSL connection between the proxy server 192 and the content provider 194. The modified request transmits to the content provider 194 using SSL encryption. The content provider 194 receives the UID from the modified message, verifies that the wireless device is authorized to receive the request content, initiates an SSL connection with the wireless device 190 and transmits the requested information to the wireless device 190 using SSL encryption.

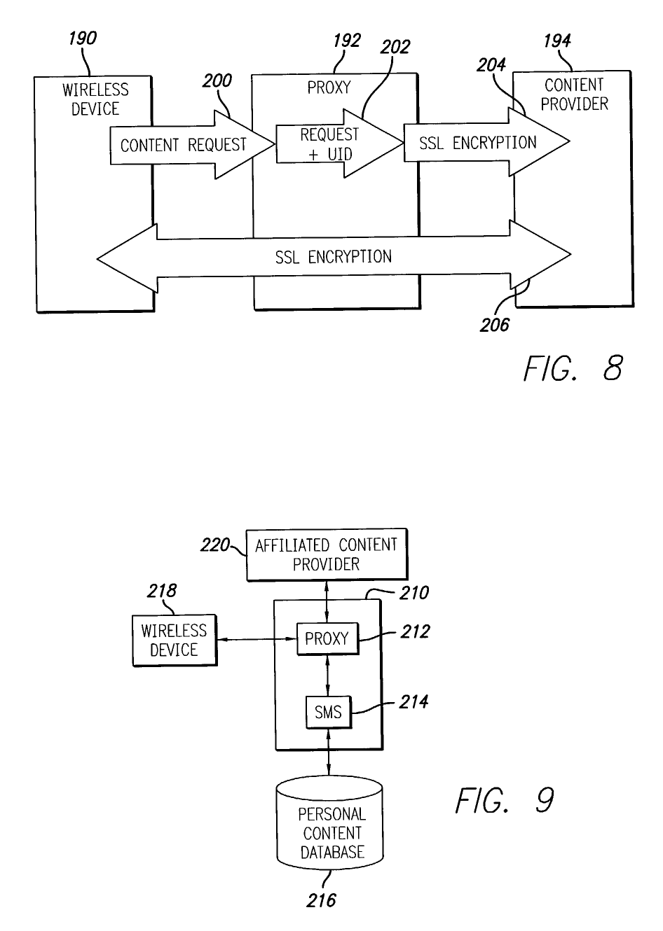

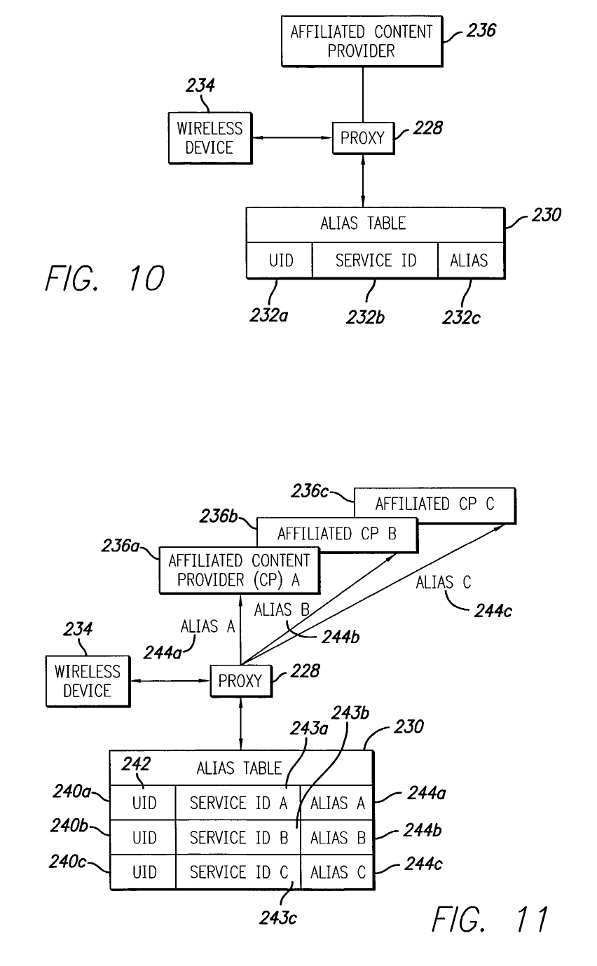

A sixth alternate embodiment will now be described with reference to FIG. 9. A subscription system 210 includes a proxy server 212, an SMS 214 and a personal content database 216. When a wireless device 218 attempts to download subscription content from an affiliated content provider 220, there is a possibility that the download will be unsuccessful. For example, the wireless device 218 may be out of the coverage area of the mobile network. If the wireless device 218 is unable to download request subscription content before the expiration of subscription, then the mobile user will need to pay twice for the same content. To assist the wireless device 218, the subscription system 210 is adapted to download subscription content to the personal content database 216. The wireless device 218 may then access the subscription content directly from the subscription system 210. In operation, the wireless device 218 requests content from the affiliated content provider 220. The proxy server 212 receives the request, modifies the request with the UID and forwards the request to the SMS 214, which requests the content directly from the affiliated content provider 220. The SMS 214 stores the requested content in the personal content database 216. In a preferred embodiment, the personal content database 216 is accessible to the wireless device 218 through a local mobile portal that interfaces directly with the SMS 214 and may be accessed in the same manner as an affiliated content provider 220.

A seventh alternate embodiment will now be described with reference to FIG. 10. In this embodiment, a proxy server 228 maintains an alias table 230 that includes a record for a unique UID 232a, Service ID 232b pair known by the proxy 228. When the proxy 228 receives a request from a wireless device 234 for content from an affiliated content provider 236, the proxy 228 locates the UID of the wireless device 234 and the service ID of the requested subscription service in the alias table 230 and retrieves the corresponding alias. The request is modified with the alias and forwarded to the affiliated content provider 236, which uses the alias to verify the identity of the mobile user. In a preferred embodiment, each entry in the alias table includes a unique alias 232c. In this manner, the use of an alias adds a level of security because each alias is only valid for a single subscription service.

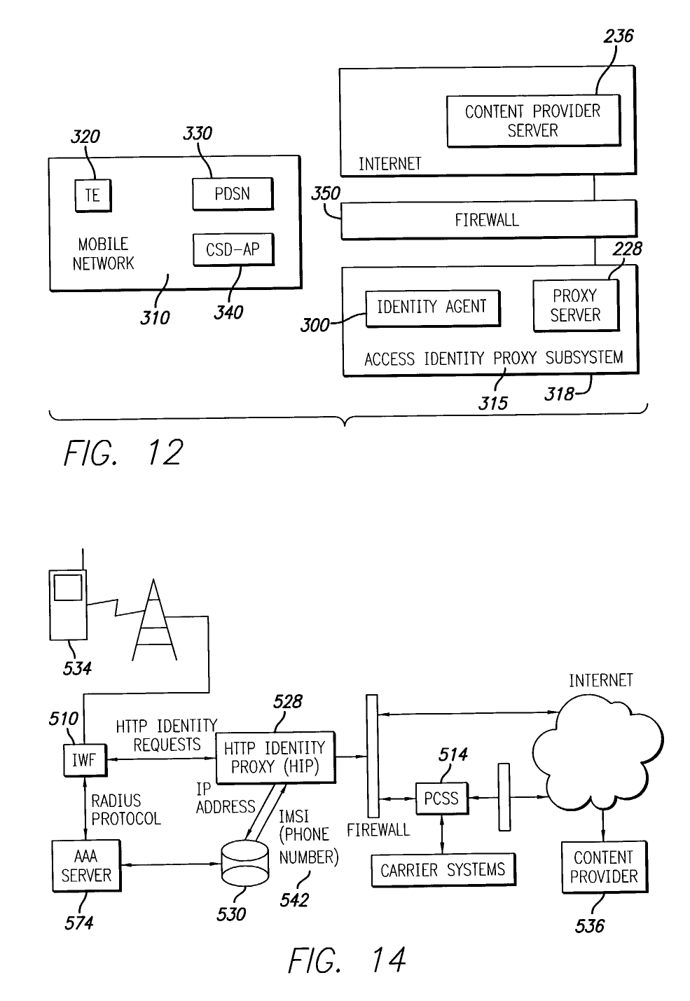

An eighth alternate embodiment will now be described with reference to FIG. 11. In FIG. 11, a wireless device 234 is shown to be able to communicate with a first affiliated content provider 236a, a second affiliated content provider 236b, and a third affiliated content provider 236c. A proxy server 228 maintains an alias table 230. The alias table is shown to include a first row 240a for a unique UID 242, service ID 243a pair, a second row 240b for a unique UID 242, Service ID 243b pair, and a third row 240c for a unique UID 242, service ID 243c pair. When the proxy server 228 receives a request from the wireless device 234 for content from any of the affiliated content providers 236a-236c, the proxy 228 locates the UID 242 of the wireless device 234 and the service IDs 243a-243c of the requested subscription service in the alias table 230. The proxy server 228 then uses the UID 242 and the service IDs 243a-243c to map to a corresponding alias 244a, 244b, or 244c and retrieves the mapped alias 244a, 244b, or 244c. In one embodiment, the same UID 242 and service ID 243 is always mapped to the same alias 244.

The request from the wireless device 234 is then modified by the proxy server 228 with the mapped alias 244a, 244b, or 244c. The proxy server 228 then forwards to the affiliated content provider 236a, 236b, or 236c that uses the alias mapped 244a, 244b, or 244c to verify the identity of the mobile user on the wireless device 234. In a preferred embodiment, each entry in the alias table 230 includes unique aliases 244a-244c. The entry may be a row (e.g., 240a, b, or c) in the alias table 230 that includes a UID (e.g., 242), a service ID (e.g., 243a, b, or c), and an alias (e.g., 244a, b, or c) generated from the UID and the service ID. In this manner, the use of an alias adds a level of security because each alias is only valid for a single subscription service. In addition, the affiliated content provider 236a, 236b, or 236c may implement a separate database with the subscription status of each affiliated user (e.g., status on whether the user is allowed access to the desired content). The database determines the subscription status by using the alias 244a, 244b, or 244c that have been forwarded to the affiliated content provider 236a, 236b, or 236c. The database may be created in a separate series of transactions between a SMS (not shown) associated with the proxy server 228 and the affiliated content provider 236a, 236b, and/or 236c.

The UID (e.g., 242) can be anything that uniquely identifies the user on the wireless device (e.g., 234). The UID (e.g., 242) may be an International Mobile Subscriber Identifier (IMSI), a phone number, a hash, or a MD5 hash of the IMSI and/or the phone number. An example UID 242 is 650-555-1212. In addition, the wireless device (e.g., 234) may contain a hardware identifier. The hardware identifier in this embodiment is similar to the one described in FIG. 7 of the present invention. That is when the wireless device is coupled to a wireless/Internet gateway (e.g., 174 in FIG. 7), the wireless/Internet gateway receives the hardware identifier from the wireless device and assigns an available IP address to the wireless devices. The wireless/Internet gateway is coupled to a lookup table (e.g. 178 in FIG. 7) that stores a mapping of UIDs (e.g., 242) to hardware IDs. The wireless/Internet gateway looks up the received hardware ID, and transmits the corresponding UID (e.g., 242) and an assigned IP address to the proxy server (e.g., 228) to notify the proxy server that the wireless device has connected to the network. The proxy server maintains a second lookup table (e.g., 180 in FIG. 7) that maps UID to assigned IP addresses and stores the received UID/IP address pair in the second lookup table. The wireless/Internet gateway is in a carrier (e.g., 170 in FIG. 7) that also incorporates the proxy server (e.g., 228).

When the proxy server receives a request from the wireless device for content from an affiliated content provider (e.g., 236a, 236b, or 236c), the proxy server receives the IP address assigned to the wireless device. The proxy server then looks up the received IP address in the second lookup table (e.g., 180 in FIG. 7) to determine the corresponding UID (e.g., 242). The proxy may then insert the UID into the request to identify the wireless device to the affiliated content provider.

Referring now back to FIG. 11, each of the service IDs 243a-243c may be either an Internet Protocol (IP) address for a server of a content provider (e.g., 191.168.3.1) or a Uniform Resource Locator (URL) of the content provider (e.g., www.yahoo.com).

The retrieved corresponding alias 244 can be an arbitrary string based on an algorithm and/or function used to generate it from the UID 242 and the service ID 243. An example of an alias 244 is an arbitrary string such as, “abcdef.” Moreover in one embodiment of the present invention, the proxy server 228 adds a header for identifying the alias 244 to the HTTP request. For example, the header can be in the form of: x-access-subnym: abcdef.

The algorithm and/or function used to generate the alias 244 may be a subnym algorithm. In the context of subnym algorithm implementation embodiment, the “subnym” may be defined as the “alias” (e.g., 244) described above. In the subnym algorithm, for every proxied HTTP request an AIKODXNS flow (i.e., each of the components/steps of the algorithm are ordered/represented by a letter, e.g., “A,” “I,” “K,” “O,” “D,” “X,” “N,” “S”) will result. That is if:

A is the IP address of the wireless device 234 originating the request;

I is the 128-bit subscriber identity or UID 242 corresponding to A;

K is a 128-bit secret key known only to the proxy server 228 and/or a carrier that encompasses the proxy server 228;

O is the RFC2396 netloc (e.g., in a URL http://www.ietf.com/rfc/rfc2396.txt, the netloc is www.ietf.com) of the request URL or service ID 243a, 243b, or 243c (from the wireless device 234);

D is the 128-bit MD5 digest of O;

X is a 256-bit value which consists of O concatenated with I;

N is the result of encrypting X with key K with an Advanced Encryption Standard (AES); and

S is the base64 encoding of N.

In this algorithmic embodiment, the proxy server 228 will send S (e.g., the subnym or the alias) as the value of the x-access-subnym header to the affiliated content provider 236a, 236b, or 236c associated with the URL. If an error occurs and the subnym cannot be computed, the proxy server 228 will send the string “UNKNOWN” to the content provider 236a, 236b, or 236c.

In a more specific embodiment of the present invention, the proxy server (e.g., 228 in FIG. 11) is a Hypertext Transfer Protocol (HTTP) Identity Proxy (HIP) server. The HIP server is a Wireless Application Protocol (WAP) 2 compliant HTTP proxy server which translates network-specific identity information into a secure, private subscriber identity, or “subnym,” which it sends to the origin server (i.e., external content provider) with every cleartext HTTP request. The HIP server adds an “x-access-subnym” header to every HTTP request it proxies. The subnym (or alias) value is a 16-byte base64-encoded ID computed by encrypting the subscriber's network identity (or UID)—e.g., an MD5 hash of the IMSI (phone number) “salted” (combined) with some per-subscriber database information—encrypted with a secret key and an MD5 of the netloc (full domain name) of the request URL (or service ID). The result is a unique identity (or subnym or alias) that is:

constant for a given subscriber and origin server (or content provider);

can be decrypted only with knowledge of the secret key, which only the carrier has;

cannot be correlated between origin servers (content providers) to track a subscriber's browsing patterns, ensuring maximum privacy; and

does not compromise the user's IMSI even if the secret key is compromised.

Moreover, in the context of this specific embodiment, the term “subnym” may be referred to as an alias and/or a unique provider-specific user identifier shared with a content provider.

Referring now to FIG. 12, a network layout in accordance with one embodiment of the present invention is illustrated. In this embodiment, an identity proxy subsystem 318 includes the proxy server 228 and an identity agent 300. The accesses identify proxy subsystem 218 is connected and protected from the affiliated content provider 236 via a firewall 350 to prevent unauthorized access. A mobile network 310 includes a terminal equipment (TE) 320 (or a wireless device), a Packet Data Serving Node (PDSN)330 for supporting the CDMA protocol, and a Circuit Switched Data Access Point (CSD-AP) 340. The mobile network 310 facilitates communication between the TE 320 (or the wireless device) and the affiliated content provider 236. In this embodiment, the proxy server 228 is a HIP server and all mobile-originated HTTP requests are routed through the HIP server, which adds identity information to every request. The identity agent 300 implements an abstract interface that maps every TE IP address to a network-specific identity (or UID), Such as IMSI (e.g., a phone number). The identity agent 300 is an integration component of the proxy server 228; the identity agent 300 should be customized for every deployment. The identity agent's internal implementation depends on the mechanisms internally supported by the mobile network's IP gateway, such as Gateway General Packet Radio Service Support Node (GGSN) for supporting the GSM protocol, CSD-AP, Remote Authentication Dial-In User Service. (RADIUS) server, etc. The identity agent 300 is coupled to the proxy server 228 (more specifically the HIP server) via an HIP Identity Interface 315. The HIP Identity Interface 315 mediates communication between the proxy server 228 and the identity agent 300.

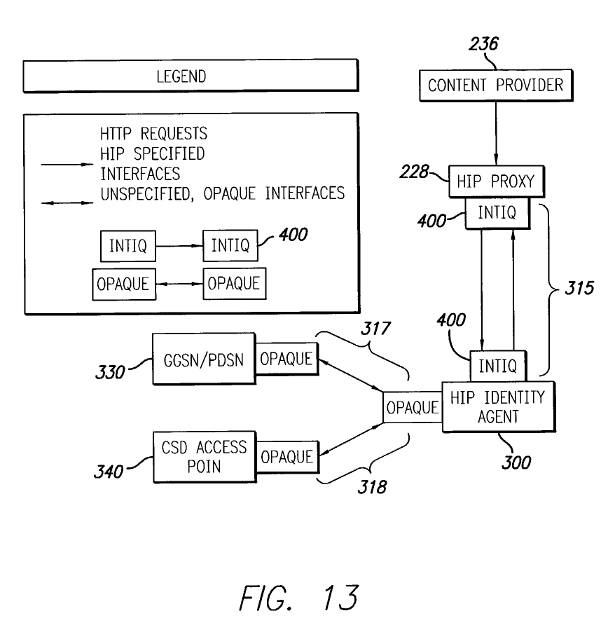

An interface usage map according to one embodiment of the present invention is illustrated in FIG. 13. In this embodiment, the HIP Identity interface 315 includes two “IntIQ” interfaces 400 as illustrated in FIG. 13. One of the IntIQ 400 interfaces with the HIP proxy server 228 and the other IntIQ 400 interfaces with the HIP identity agent 300. The PDSN 330 is connected with the identity agent 300 via a first unspecified or opaque interface 317 and the CSD-AP 340 is connected with the identity agent 300 via a second unspecified or opaque interface 318.

In one embodiment of the present invention, the HIP server 228 is a Request for Comment (RFC) 2616 compliant HTTP 1.1 proxy server and a WAP2 compliant gateway. In addition, the HIP server 228 adds a secure, private identity header, such as a “x-access-subnym,” to every HTTP request it proxies. The x-access-subnym header sends the subscriber's identity, or subnym, or alias, to the origin server (or the content provider 236). The subnym (or alias) may be used for a number of purposes. For example, unlike cookies, the subnym can track web users reliably and permanently without login or login renewal. However, the main function of the subnym is to enable coordination of subscriber information (e.g., the UID and the service ID) between the origin server (or the content provider) and the carrier (that includes the proxy server 228). The presence of the x-access-subnym header indicates that the HIP server 228 and the components it is attached to are functioning correctly. In the case of errors in the underlying subsystems, HIP server 228 can send a fixed value in place of the network identity subnym. The fixed value may be defined and configured in the present embodiment as an unknown subnym header value. The fixed value should also be decided on at the operator level, and all HIP instances (if installed in a load-balanced configuration) should have identical settings. Alternatively, the HIP server 228 may be capable of setting the header to a null value, in which case the header in the cases of errors is not sent to the content provider 236 at all. The null valued header should be the preferred setting for the HIP server 228 on errors because this setting saves network bandwidth.

In one embodiment of the present invention, the subnym architecture has a plurality of features. The plurality of features include a feature to define a unique identity that is constant for each pair (subscriber or UID, service ID); a feature to reveal no other subscriber information to the origin server; a feature for preventing multiple unrelated origin servers from correlating identity to track traffic; and a feature to computationally reverse the internal subscriber identity (or UID) given a carrier secret key (i.e., the internal subscriber number can be extracted from the subnym, if the carrier secret encryption key is known); and a feature to prevent disclosure of a single carrier secret encryption key from compromising all subscribers. In this embodiment, the identity consistency of the subnym is as consistent as the consistency of its components—origin server identity (or service ID) and subscriber identity (or UID). In the context of the present embodiment, the origin server identity can be defined as the fully qualified domain name of the server. In RFC 2396 note, the origin server identity may be further referred to as a netloc. For example, in the URL http://www.ietf.com/rfc/rfc2396.txt, the netloc is www.ietf.com. In addition, because one content provider (e.g., 236 in FIG. 10) often controls and uses multiple servers, the content providers of the present invention should be implemented to choose a single origin server domain name which defines a canonical identity, route all identity-sensitive browsing sessions through that server, and use URL rewriting or another session state model to embed the canonical identity in all requests, which are directed to other servers. This is similar to the solutions provided in above described embodiments for secure (i.e., SSL/TLS, also known as https:) requests shown in FIG. 8. In addition, the process of obfuscating and encrypting the UID and the service ID (e.g., netloc) to produce the subnym is not one-way because given a subnym and a carrier key, the UID and the service ID (e.g., the netloc) can be derived.

In one embodiment of the present invention and according to the foregoing, a subnym can be generated from the AIKODXNS (or subnym) algorithm. In the AIKODXNS algorithm, the various steps in the algorithm are represented by a letter (e.g., “A,” “I,” “K,” “O,” “D,” “X,” “N,” “S”). The is in the AIKSDXNS for every proxied HTTP request, where:

A is the IP address of the TE originating the request;

I is the 128-bit subscriber identity (as provided by the identity agent) corresponding to A;

K is a 128-bit secret key known only to the carrier;

O is the RFC2396 netloc of the request URL;

D is the 128-bit MD5 digest of O;

X is a 256-bit value which consists of O concatenated with I;

N is the result of encrypting X with key K with AES (Advanced Encryption Standard); and

S is the base64 encoding of N.

The HIP server will send S as the value of the x-access-subnym header. If an error occurs and the subnym cannot be computed, it will send the string “UNKNOWN.”

In one embodiment, the HIP server is an RFC 2616 note compliant HTTP 1.1 proxy server. The HIP server may also implement the CONNECT method as specified in RFC 2817 note. In addition, depending on configuration, the HIP server may implement an RFC 2616 a HTTP compliant cache. Moreover, depending on configuration, the HIP server may implement a deflate or zlib HTTP content-encoding compression to reduce bandwidth over the air. However, because the compression feature results in a considerable increase in the computational needs of the HIP server and can only work with clients which support the same content-encoding methods (which are recommended but not required by WAP2), preferably, the compression feature is configured only with the HIP server if such feature is required to reduce over-the-air traffic cost. Lastly, the HIP server should be a WAP2 conformant HTTP gateway.

In one embodiment of the present invention, the identity agent is an integration component of the HIP server. The identity agent stores the complete set of active mappings between a TE IP address and it's corresponding network identity (or UID) and serves them to the HIP server. In this embodiment, the identity agent is abstracted from the core proxy server because managing the IP-identity mapping is a difficult task. The mapping should be implemented with the network element that routes IP packets (e.g., GGSN/PDSN). The table of mappings that would be active on the network should be stored in a persistent and very reliable database. The database should be very reliable because if the mapping table crashes, the identities of all currently active devices on the network will be lost; those devices will be unable to access identity-enabled services (such as premium content) until they reset their IP addresses.

The location and structure of this very reliable database are network-dependent. For example, the database may be a built-in component of the GGSN/PDSN, which is available through a network database interface protocol. Alternatively, if the GGSN/PDSN does not export such an interface, it may support proxying to an external Remote Authentication Dial-In User Service (RADIUS) Authentication (AAA) server. In that case, the identity agent implementation should include such an AAA server which accepts AAA messages, writes the mappings they report to a database, and reads from the database to service identity requests. An identity agent request/response interface may be used to hide these implementation details.

In addition, because access to a network database may take a nontrivial amount of time, and since one embodiment of the present invention sends identity with every HTTP request, the identity agent should implement an in-memory cache that stores recently used identity mappings. To implement this cache, one database embodiment of the present invention uses either a configured period of time for which the network will leave an IP address idle before reassigning it to a new user (for example, 5 minutes), or some interface to the GGSN/PDSN that informs the database whenever an address is invalidated.

The configured period of time before reassigning an IP address database embodiment is preferred because it is simpler and more reliable. That is, since servers that assign IP addresses tend to use an LRU (least recently-used) algorithm, any network that is not close to exceeding its IP address pool should be able to guarantee a significant address downtime.

In a further embodiment, the identity agent listens on a Transmission Control Protocol (TCP) port. For example, the 19982 TCP port may be used by default. Like an HTTP server, the identity agent should accept an arbitrary number of simultaneous connections (e.g., corresponding to multiple proxy server processes). Therefore, the identity agent should either be implemented with (or started from) a spawning server such as inetd or a sever that includes comparable functionality.

The identity agent may also run on the same server as the HIP server, and in most deployments probably will, but the identity may also be a separate server that communicates across the network with the HIP server for flexibility reasons.

An implementation of the HIP identity agent should keep the connection open after each response and be able to accept a new request on the same connection. The identity agent may be implemented with an ability to close the connection if necessary, although this will negatively impact performance of an HIP server and HIP identity agent communication.

In one embodiment, the actual identity data exported by the identity agent is opaque (i.e., not known) to the HIP server, but to maximize security, certain guidelines should be followed. For example, if the identity type (or UID) is simply the IMSI (phone number) of the subscriber, any compromise of the carrier's secret identity key will compromise all IMSI of every subscriber. To avoid this, the identity type should be an MD5 (hash digest) of the IMSI, which is “salted” (combined) with some private per-subscriber data. Salting prevents an attacker who has stolen the server's private key from reversing the algorithm, comparing identities to known IMSI values.

A carrier infrastructure integration according to one embodiment of the present invention is illustrated in FIG. 14. In FIG. 14, a Premium Content Subscription Server (PCSS) or SMS 514 works together with an HIP sever 528 to enable a carrier system 500 (and/or a carrier 100 in FIG. 4) to provide premium content subscriptions to its customers. In this embodiment, it is assumed that an AAA server 574 or a wireless/Internet gateway 510 writes the authentication mappings: IP address to user identity of some sort (e.g., PCSS “internal ID” or UID) to an identity agent 530 having a very reliable database. The HIP server 528 then queries the database of the identity agent by sending an IP address assigned to a wireless device 534 and getting back the identity (or UID) associated with the wireless device 534. Because this happens on every request, the present embodiment comprises a caching mechanism (not shown) to ensure that the database of the identity agent 530 is not read every time a user clicks a link. Because of the use of the caching mechanism, the present embodiment also uses a guaranteed time during which an IP address will not be reused. That is, if the IP address is reused within this time period (e.g., two minutes), the pool of IP addresses may be exhausted. The IP addresses should also be assigned in round-robin order and a minimum of about two minutes should be used as the guaranteed time. Lastly, a translation device, such as an InterWorking Function (IWF) 510, is situated between the wireless device 534 and an affiliated content provider 536. The IWF 510 performs the translation between a mobile air channel format (e.g., signals sent and received by wireless device 534) and a Public Switched Telephone Network (PSTN) Pulse Code Modulation (PCM) format. An example of this is that the wireless device 534 sends and receives character data via the cellular air interface, and then modulates it for the PSTN at the IWF 510.

In general, according to the foregoing, the invention provides an exemplary method for selecting an alias for a wireless device from a proxy server and providing this alias to a content provider. Referring now also to FIG. 11, a user on wireless device 234 makes a request for content from an affiliated content provider (or affiliated content provider A) 236a. The request is of the form of an HTTP request. The request travels from the wireless device 234 (where it is a request over a radio frequency) thru one or more infrastructure devices (e.g., an IWF 510 in FIG. 14) until it arrives as the HTTP request over an Ethernet at the proxy server 228. Using standard socket Application Program Interfaces (APIs), the proxy server 228 requests the source IP address for the request it just received. The proxy server sends the IP address to an identity agent (e.g., 530 in FIG. 14) and is given the UID 242 for that IP. The UID 242 may be the IMSI 542 in FIG. 14. The proxy server 228 looks at the HTTP request to determine which server's (or content provider's) data is being requested. In this embodiment, this server may be the content provider 236a (or content provider A) illustrated in FIG. 11 and/or the content provider 536 in FIG. 14. The content provider A 236a is addressed by either a URL or an IP address. This URL or IP address may be the service ID 243a illustrated in FIG. 11. Using the algorithm documented above (e.g., the subnym algorithm), an alias 244a is calculated from the UID 242 and service ID 243a (or, if it was already calculated, it can be looked up in a table where the previous calculation was recorded). The alias 244a is attached to the HTTP request by means of inserting an additional header (e.g., x-access-subnym) to the request. The HTTP request is forwarded to the affiliated content provider 236a with the appended alias 244a. The affiliated content provider 236a uses the alias 244a to determine the identity of the user.

In one embodiment, the present invention is implemented with a Solaris 8 or Red Hat Linux v7.2 (kernel v2.4) operating system and a load balanced Sun Enterprise 450s or Dell PowerEdge 1550 or IBM x330 model server. Because the proxy server may be a standard Apache HTTP proxy server, scalability can be achieved by any of the usual means used to manage Apache and other HTTP servers, such as off-the-shelf TCP load balancers and Linux clusters. Likewise, error management and logging uses the standard Apache logs.

Having thus described embodiments of the present invention, it should be apparent to those skilled in the art that certain advantages of the within system have been achieved. It should also be appreciated that various modifications, adaptations, and alternative embodiments thereof may be made within the scope and spirit of the present invention. For example, the management of message blocks for an HIP proxy server have been illustrated, but it should be apparent that the inventive concepts described above would be equally applicable to other types of network proxy servers. The invention is further defined by the following claims.

1. A wireless communications system for providing content services to wireless devices, the system comprising:
a content provider associated with a first content provider-specific identifier and a second content provider-specific identifier;
a first network;
a proxy server coupled with the content provider via the first network, the proxy server comprising a table, the table having the first content provider-specific identifier;
a second network; and
a wireless device server associated with a first wireless device identifier and a second wireless device identifier and coupled with the proxy server via the second network, the wireless device providing the second content provider-specific identifier;
wherein the proxy server uses the first wireless device identifier to identify the second wireless device identifier;
wherein the proxy server uses the second wireless device identifier and the second content provider-specific identifier to identify the first content provider-specific identifier on the table;
wherein the proxy server adds the first content provider-specific identifier to a header;
wherein the proxy server forwards the modified first content provider-specific identifier to the content provider; and
wherein the content provider uses the modified first content provider-specific identifier to determine an identity of the wireless device.

2. The system of claim 1, further comprising a subscription management server and wherein the proxy server forwards the second wireless device identifier and the second content provider-specific identifier to the subscription management server if the content provider is an affiliated content provider.

3. The system of claim 2, further comprising a billing system and wherein the billing system interfaces with the subscription management server to bill the wireless devices for usage of the content provider.

4. The system of claim 3, further comprising a user counter for tracking a number of data packets transmitted to the wireless device from the content provider and wherein the billing system further interfaces with the user counter to bill the wireless device for usage of the number of data packets transmitted to the wireless device from the content provider.

5. The system of claim 4, wherein the billing system is configured to handle both a pre-paid model and a post-paid model.

6. The system of claim 1, wherein the second network is a wireless network.

7 The system of claim 6, further comprising a firewall and wherein the second network is separated from the first network via the firewall.

8. The system of claim 7, wherein the wireless network comprises a translation device for translating a data format from the wireless device into a data format acceptable to the proxy server.

9. The system of claim 8, wherein the wireless network comprises both a Packet Data Service Node and a General Packet Radio Service Support Node and wherein the nodes allow the wireless network to support both GSM and CDMA protocols.

10. The system of claim 1, wherein the wireless device comprises a hardware identifier.

11. The system of claim 10, further comprising a wireless/Internet gateway and wherein the wireless/Internet gateway receives the hardware identifier from the wireless device and assigns an available internet protocol (IP) address as the first wireless device identifier to the wireless devices.

12. The system of claim 11, wherein the wireless/Internet gateway is coupled to a lookup table that stores a mapping of the second wireless device identifier with the hardware identifier.

13. The system of claim 12, wherein the wireless/Internet gateway transmits the second wireless device identifier and the assigned IP address to the proxy server to notify the proxy server that the wireless device is connected to the wireless network.

14. The system of claim 13, wherein the proxy server maintains a second lookup table that maps the second wireless device identifier to the assigned IP address.

15. The system of claim 14, wherein when the proxy server receives a request from the wireless device for content from a content provider, the proxy server also receives the IP address assigned to the wireless device.

16. The system of claim 15, wherein the proxy server uses the received IP address to identify the second wireless device identifier.

17. The system of claim 1, wherein the proxy server comprises an identity agent and wherein the second network is coupled with the proxy server via the identity agent.

18. The system of claim 17, wherein the identity agent provides the second wireless device identifier to the proxy server.

19. The system of claim 18, wherein the proxy server provides the first wireless device identifier to the identity agent before the identity agent provides the second wireless device identifier to the proxy server.

20. The system of claim 19, wherein the second wireless device identifier comprises an International Mobile Subscriber Identifier.

21. The system of claim 1, further comprising a carrier associated with the proxy server and a secret key known only to the carrier and wherein the first content provider-specific identifier is encrypted with the secret key.

22. The system of claim 21, wherein the encrypted first content provider-specific identifier cannot be correlated by the content provider to track browsing patterns of the wireless device.

23. The system of claim 21, wherein the second wireless device identifier can be extracted from the encrypted first content provider-specific identifier, if the secret key is known.

24. The system of claim 1, wherein the header comprises one of a header for indicating an error and a header for indicating that the first content provider-specific identifier can be provided.

25. The system of claim 1, wherein the content provider can substitute a single canonical identifier for a plurality of content provider-specific identifiers when those identifiers belong to a single content service.

26. The system of claim 1, further comprising a personal content database coupled to the proxy server and wherein the personal content database is used as a cache to guarantee reliability for wireless content downloading.

27. A method for providing content services to wireless devices, the method comprising:
making a content request from a wireless device for content services from a content provider, wherein the content request is in a wireless format;
transmitting the content request from the wireless device thru a wireless infrastructure device to a proxy server;
requesting from the proxy server an Internet Protocol (IP) address assigned to the wireless device;
transmitting from the proxy server the assigned IP address to an identity agent;
corresponding a user identifier associated with the wireless device with the assigned IP address at the identity agent;
transmitting from the identity agent the user identifier to the proxy server;
determining an identity of the content provider from the request, wherein the request comprises a first content provider-specific identifier for the content provider;
using an algorithm to calculate a second content provider-specific identifier from the first content provider-specific identifier and the user identifier;
appending a header to the second content provider-specific identifier;
modifying the content request with the appended second content provider-specific identifier;
forwarding the modified content request to the content provider; and
determining from the modified content request an identity of the wireless device at the content provider.

28. The method of claim 27, further comprising the step of converting the content request in the wireless format into a Hypertext Transfer Protocol (HTTP) format when the content request passes thru the wireless infrastructure device.

29. The method of claim 27, wherein the algorithm comprises a subnym algorithm.

30. The method of claim 27, further comprising the step of substituting at the content provider a single canonical identifier for a plurality of content provider-specific identifiers when those identifiers belong to a single content service.

31. The method of claim 27, further comprising the step of using a personal content database as a cache to guarantee reliability for wireless content downloading.
